(19) United States
(12) Patent Application Publication
(10) Pub. No.: US 2016/0101983 A1
(43) Pub. Date: Apr. 14, 2016

(54) METHOD OF PREPARING TRICHLOROSILANE

(71) Applicant: HANWHA CHEMICAL CORPORATION, Seoul (KR)

(72) Inventors: Gil Ho KIM, Daejeon (KR); Gui Ryong AHN, Daejeon (KR); Won Ik LEE, Seoul (KR); Joon Hwan KIM, Daejeon (KR); Kyu Hak PARK, Incheon (KR)

(21) Appl. No.: 14/893,132

(22) PCT Filed: Jun. 18, 2014
(86) PCT No.: PCT/KR2014/005369

§ 371 Date: Nov. 23, 2015

(30) Foreign Application Priority Data
Jun. 19, 2013 (KR) 10-2013-0070513

(51) Int. Cl. C01B 33/107

(52) U.S. Cl. CPC C01B 33/10763

(57) ABSTRACT

This invention relates to a method of preparing trichlorosilane, which enables trichlorosilane to be obtained at improved yield using silicon having copper silicide uniformly formed thereon, by uniformly distributing and applying a copper compound on the surface of silicon and then performing heat treatment.

### TECHNICAL FIELD

The present invention relates to a method of preparing trichlorosilane. More particularly, the present invention relates to a method of preparing trichlorosilane, which enables trichlorosilane to be obtained at improved yield by uniformly forming copper silicide on the surface of silicon using a solution containing a copper compound.

### BACKGROUND ART

Trichlorosilane (TCS) is the most important material for preparing silicon for use in a semiconductor or a solar cell. Examples of preparation of trichlorosilane include direct chlorination and hydrochlorination (HC), which are currently commercially utilized. Hydrochlorination is a reaction process of supplying silicon tetrachloride (STC) and hydrogen (H₂) to metallurgical silicon (MG-Si) to produce trichlorosilane at a high temperature of 500 to 600° C. and a high pressure of 20 to 30 bar.

Various methods have been proposed to increase the reaction rate of hydrochlorination. Japanese Patent Application Publication Nos. 1981-073617 and 1985-036318 disclose a method of adding a copper (Cu) catalyst, and Japanese Patent Application Publication No. 1988-100015 discloses a method of adding a Cu mixture to the reaction.

A Cu catalyst is known to contribute to an increase in the yield of trichlorosilane in a fixed bed reactor but to exhibit low contribution to a commercial process because Cu particles may aggregate due to the small particle size thereof and are difficult to be made to come into contact with the surface of MG-Si in a fluidized bed reactor. In order to solve these problems, although a variety of attempts have been made to support a Cu catalyst on the surface of MG-Si as in Japanese Patent No. 3708649 and Korean Patent Application No. 2007-7023115, they are problematic in that the preparation process is difficult and becomes complicated. Furthermore, because the Cu catalyst is partially present on the surface of MG-Si, synthesis of trichlorosilane is not carried out throughout MG-Si.

### DISCLOSURE

### Technical Problem

Accordingly, the present invention has been made keeping in mind the above problems occurring in the related art, and an object of the present invention is to provide a method of preparing trichlorosilane, which is simple and efficient, may be industrially applied, and enables trichlorosliane to be obtained at high yield by uniformly forming a Cu catalyst on the surface of Si.

### Technical Solution

In order to accomplish the above object, the present invention provides a method of preparing trichlorosilane, comprising forming a Cu compound coating layer on Si; heat treating Si having the Cu compound coating layer formed thereon to a temperature equal to or higher than the melting temperature of the Cu compound to form Cu-silicide on Si; and supplying silicon tetrachloride and hydrogen to the Si having Cu-silicide to carry out hydrochlorination.

### Advantageous Effects

According to the present invention, a method of preparing trichlorosilane enables trichlorosilane to be continuously and efficiently prepared at improved yield by carrying out hydrochlorination using Si having Cu-silicide uniformly formed thereon using a solution process.

### DESCRIPTION OF DRAWINGS

FIG. 1 illustrates coating the surface of MG-Si with a Cu compound using a solution process;

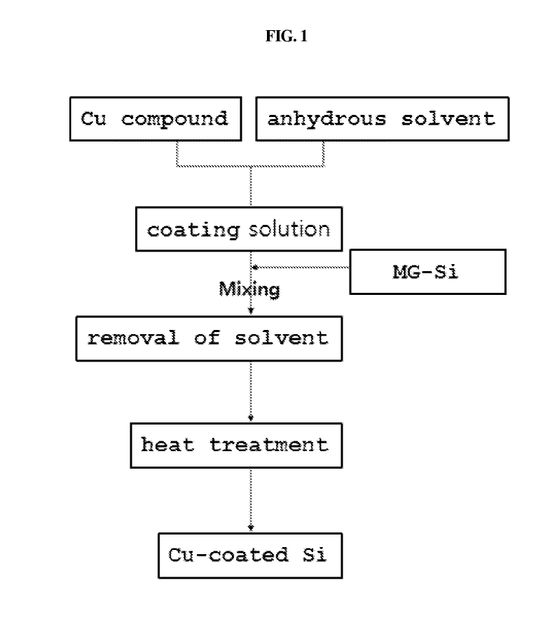

FIG. 2 illustrates the results of observing MG-Si of Example 1 before and after heat treatment and MG-Si having no Cu compound of Comparative Example 1 by XRD (X-ray diffraction patterns);

FIG. 3 illustrates the results of observing the surface of MG-Si of Example 1 and Comparative Examples 1 and 2 using SEM (Scanning Electron Microscope);

FIG. 4 illustrates the results of measuring Example 1 and Comparative Examples 1 and 2 using SEM-EDX (Energy-dispersive X-ray spectroscopy);

FIG. 5 illustrates the results of observing the surface of Example 1 after heat treatment by SEM and SEM-EDX; and

FIG. 6 is a graph illustrating the yield of trichlorosilane (SiHCl₃) depending on the reaction time in Example 1 and Comparative Examples 1 and 2.

### MODE FOR INVENTION

As used herein, the terms a first, a second, and the like are used to explain various constitutional elements, and the terms are used only to distinguish one constitutional element from the other constitutional elements.

And, the terms used herein are used only to explain illustrative examples, and are not intended to limit the invention. A singular expression includes a plural expression unless otherwise clearly indicated. As used herein, the terms “comprise”, “include”, or “have” designate that described characteristics, numbers, steps, constitutional elements or combinations thereof are exist, but it should be understood that they do not previously exclude the possibility of existence or adding of one or more other characteristics, numbers, steps, constitutional elements or combinations thereof.

Also, as used herein, in case a layer or an element is mentioned to be formed “on” layers or elements, it means that the layer or element is directly formed on the layers or elements, or it means that other layers or elements may be additionally formed between the layers, on a subject, or on a substrate.

Although the present invention may have various forms and various modifications may be made thereto, specific examples will be exemplified and explained in detail. However, it is not intended to limit the present invention to disclosed forms, and it should be understood that all the modifications, equivalents or substitutions within the idea and technical scope of the present invention are included in the present invention.

Hereinafter, a detailed description will be given of a method of preparing trichorosilane according to the present invention.

The method of preparing trichlorosilane according to the present invention comprises forming a copper (Cu) compound coating layer on silicon (Si); heat treating Si having the Cu compound coating layer formed thereon to a temperature equal to or higher than the melting temperature of the Cu compound to form Cu-silicide on Si; and supplying silicon tetrachloride and hydrogen to the Si having Cu-silicide formed thereon to carry out hydrochlorination.

Especially, the present invention adopts a solution process using a solution containing a Cu compound, and thereby the Cu compound is uniformly applied on the surface of Si and thermally treated.

Examples of preparation of the trichorosilane mainly include direct chlorination and hydrochlorination (HC), which are currently commercially utilized.

Hydrochlorination is a reaction process of reacting Si with silicon tetrachloride (STC) and hydrogen (H₂) to produce trichlorosilane at high temperature and high pressure, and the overall reaction is represented by the following Reaction 1.

3SiCl₄+2H₂+MG-Si→4SiHCl₃ [Reaction 1]

The overall reaction of Reaction 1 may be divided into the following two steps:

SiCl₄+H₂→SiHCl₃+HCl [Reaction 2]

3HCl+Si→SiHCl₃+H₂ [Reaction 3]

The reaction is an endothermic reaction with a heat of reaction of ΔH=37 kcal/mol, and for commercial uses, employs a fluidized bed reactor in order to enlarge the reaction area.

It is known that, when a metal such as Cu is used as a catalyst for hydrochlorination, the reaction rate and selectivity may be increased. Thus, a method of introducing a Cu compound such as CuCl or CuCl₂ into the reactor to produce trichlorosilane has been suggested, but may be problematic because the reaction flow may decrease due to aggregation of Cu particles and catalytic efficiency may be lowered. With the goal of solving such problems, various methods for forming the Cu compound on the surface of MG-Si are being explored. However, limitations are imposed on increasing the reactivity due to partial formation of Cu on the surface of MG-Si.

Hence, according to the present invention, in lieu of introducing the Cu compound as the catalyst, the Cu compound is uniformly applied on the surface of Si by use of a solution process and then heat treated to a temperature equal to or higher than the melting temperature of the Cu compound to thus uniformly form Cu-silicide on the surface of Si, after which the Si having Cu-silicide formed thereon is subjected to hydrochlorination to prepare trichlorosilane. Specifically in the present invention, Cu particles are not introduced as a catalyst, but Cu-silicide is uniformly formed on the surface of Si using a solution process and thus the surface of Si having Cu-silicide formed thereon may be reacted. Thereby, Cu-silicide functions as a catalyst for hydrochlorination, and simultaneously participates in hydrochlorination, thus improving the yield of the reaction, without causing problems related with a decrease in the reaction flow due to the aggregation of Cu particles and also with partial formation of Cu-silicide on the surface of Si.

When hydrochlorination is carried out on the surface of Si as in conventional methods without formation of a Cu-silicide coating layer, reaction with Cl ions becomes easy due to simple physical bonding between Si and the Cu compound, namely, in Cu—Si, and Cu may be converted into copper chloride (CuCl) and thus lost. However, when the Cu-silicide coating layer is formed according to the present invention, Cu is not converted into CuCl due to strong chemical bonding between Si and the Cu compound, namely, in Cu—Si, but may effectively function as a catalyst.

More specifically, forming the Cu compound coating layer on Si is first performed.

Si is not particularly limited so long as it is MG-Si of a grade that may be used for preparation of trichlorosilane, and may include, for example, MG-Si having fine particles with size of approximately 10 to 500 μm, and preferably approximately 50 to 300 μm. Si particles having a particle size which satisfies the above range may be obtained by pulverizing and classifying MG-Si mass.

Also, Si may have a purity of approximately 98% or more, and preferably approximately 99% or more, and may include metal atoms such as Al, Ca, Ni or Fe as impurities.

It is known that, when Cu or a Cu compound is added as a catalyst for a hydrochlorination reaction system, the reaction rate for producing trichlorosilane is improved to contribute to an increase in yield. However, the Cu compound has a problem in that it may inhibit the reaction flow because Si may easily aggregate in the reaction system. Also, the Cu compound has to ensure wide contact with the surface of Si so as to act as a catalyst. However, when the Cu compound is formed on the surface of Si by typical heat treatment, the Cu catalyst is partially formed on Si, and thus, it fails to increase the reaction rate to a commercially expected level.

Whereas, according to the present invention, a solution process is applied, and thus the Cu compound is not used as a catalyst, but Cu-silicide is uniformly formed on the surface of Si and hydrochlorination is carried out using Si having Cu-silicide formed thereon. Therefore, the reaction flow may be ensured because aggregation of the Cu compound does not occur. Also, the Cu catalyst is uniformly formed on the surface of Si, so that the reaction surface is enlarged, resulting in higher yield, compared to when the Cu compound in the same amount is introduced as a catalyst.

Forming the Cu compound coating layer is performed by incorporating Si in a solution containing the Cu compound. More specifically, the Cu compound is dissolved in an anhydrous solvent to prepare a coating solution containing the Cu compound, in which Si is then dispersed and incorporated with stirring. As such, the thickness and the composition of the coating layer may be controlled by adjusting the amount of the Cu compound. Thereafter, the solvent may be removed using a rotary evaporator, thus forming the coating layer on the surface of Si. The coating layer undergoes a subsequent heat treatment process, and thereby Cu-silicide may be formed on the surface of Si.

The Cu compound may include cuprous chloride (CuCl), cupric chloride (CuCl₂), cuprous oxide (Cu₂O) for cement, cupric oxide (CuO), metal copper (Cu), or mixtures thereof, but the present invention is not limited thereto.

In an embodiment of the present invention, the Cu compound is used in an amount of approximately 0.01 to 87 wt %, preferably approximately 0.1 to 20 wt %, and more preferably approximately 0.1 to 10 wt % relative to the weight of Si based on the weight of the Cu element contained in the Cu compound.

The higher the amount of the Cu compound, the higher the yield of trichlorosilane. Given the above range, the yield may be sufficiently improved from the commercial and economic points of view.

In an embodiment of the present invention, the solution containing the Cu compound may comprise one or more solvents selected from among methanol, ethanol, isopropanol and butanol, which may minimize the number of carbon and oxygen atoms. The solution may include any solvent so long as the solvent is effectively removed in the subsequent heat treatment process after dissolution of the Cu compound. The solvent may be an anhydrous solvent containing a water content of 10 wt % or less or 5 wt % or less. When water is excessively contained in the solvent, side reactions of Si and water may occur as illustrated in Reaction 4 below, and thus water is preferably minimized through the reaction with the reactant such as a solvent, etc.

Si+H₂O→SiO+HCl [Reaction 4]

Furthermore, the solution may have a concentration in the range that the Cu compound is dissolved and the Cu-silicide coating layer may thus be formed on the surface of Si. For example, the solution may include the Cu compound in a concentration of 0.05 wt % (w/v) or more or 0.1 to 50 wt % (w/v), and preferably 0.5 to 30 wt % (w/v).

In an embodiment of the present invention, the thickness of the coating layer formed on the surface of Si using the solution containing the Cu compound, namely, the thickness of the Cu compound coating layer on the surface of Si, may be set to approximately 10 μm or less or 1 nm to 10 μm, preferably 1 μm or less, and more preferably 100 nm or less. Particularly, according to the present invention, it is further preferable to form a monolayered coating layer. The thickness of the coating layer may be measured using a scanning electron micrograph.

Subsequently, heat treating Si having the Cu compound coating layer formed thereon to a temperature equal to or higher than the melting temperature of the Cu compound is performed, thereby forming Cu-silicide on Si.

Heat treatment to prepare Cu-silicide may be implemented at a temperature equal to or higher than the melting temperature of the Cu compound, for example, approximately 300 to 800° C., and preferably approximately 300 to 700° C., and at a pressure of approximately 1 to 20 bar, and preferably approximately 1 to 5 bar.

Furthermore, heat treatment may be executed in a mixed gas atmosphere containing hydrogen.

In an embodiment of the invention, the mixed gas may include approximately 10 wt % or less, for example, approximately 1 to 10 wt % of hydrogen, with the remainder of inert gas such as argon (Ar) or nitrogen (N₂). As described above, by means of heat treatment in a mixed gas atmosphere containing hydrogen, a natural oxide film is removed from the surface of Si before formation of Cu-silicide, making it easier to form Cu-silicide. However, if an excess of hydrogen is contained, the number of silicon-hydrogen bonds may increase. Hence, hydrogen is preferably contained in an amount of 10% or less, with the remainder of inert gas.

By the heat treatment process, Cu-silicide is formed on Si. According to an embodiment of the invention, Cu-silicide may be formed on the surface of Si.

In an embodiment of the invention, the coating layer of the Cu compound having a size of ones of μm is formed on the surface of Si, followed by heat treatment so that Cu-silicide is formed on the surface of Si, thereby enlarging the reaction surface area due to Cu-silicide to thus further improve reactivity of Si. For example, as Cu-silicide is formed, fine holes with a diameter of approximately 0.1 to 10 μm, and preferably approximately 1 to 5 μm, may be generated in the surface of Si. The holes formed in the surface of Si may increase the surface area of Si to further improve reactivity. Moreover, metal atoms such as Al, Ca, Ni or Fe existing as impurities in Si may be exposed to the outside and function as a catalyst, thus additionally increasing the yield.

Subsequently, supplying silicon tetrachloride (SiCl₄) and hydrogen to the Si having Cu-silicide formed thereon is performed, so that hydrochlorination is carried out.

Forming Cu-silicide and carrying out hydrochlorination may be continuously implemented. Specifically, Cu-silicide is formed by heat treatment in a reactor containing Si and the Cu compound, and silicon tetrachloride and hydrogen may be continuously supplied into the same reactor to thereby carry out hydrochlorination. As such, because the Si having Cu-silicide formed thereon plays a role in improving the reaction efficiency, hydrochlorination is carried out without the use of an additional catalyst.

In an embodiment of the invention, the hydrogen and the silicon tetrachloride may be supplied at a molar ratio of approximately 5:1 to 1:5, and preferably approximately 3:1 to 1:3.

Hydrochlorination may be carried out at a temperature of approximately 300 to 800° C. and preferably approximately 500 to 700° C., and a pressure of approximately 1 to 50 bar and preferably approximately 5 to 30 bar.

Hydrochlorination enables preparation of trichlorosilane.

By the preparation method according to the present invention, the yield may be expected to increase by approximately 15% or more, preferably 18% or more and more preferably 20% or more, compared to when a Cu compound is added alone as a catalyst.

Hereinafter, the present invention will be explained in more detail with reference to the following Examples. However, these examples are only to illustrate the invention, and the right scope of the invention is not determined thereby.

### EXAMPLES

### Example 1

MG-Si having a purity of 99% or more and an average particle size of 250 μm, and 0.85 g of CuCl₂ in an amount of 0.23 percent by weight (wt %) relative to the weight of Si based on the weight of Cu in CuCl₂ were dissolved in 100 mL of a solvent (anhydrous ethanol) to prepare a solution, and thus MG-Si was mixed. The solvent was removed from the mixed solution using a rotary evaporator, thus forming a CuCl₂ coating layer on the surface of Si. Subsequently, the temperature was elevated to 400 degrees Celsius (° C.) at a rate of 4° C./min in a mixed gas atmosphere containing hydrogen and nitrogen at a weight ratio of 1:9. The Si having the coating layer was maintained at 400° C. for 1 hr, and then cooled to room temperature, thus obtaining MG-Si having Cu-silicide formed thereon.

In a fixed bed reactor, 170 g of the MG-Si having Cu-silicide formed thereon was placed, after which hydrochlorination was carried out for 2 to 10 hr under conditions of a temperature of 525° C., a pressure of 20 barG, and a molar ratio of H₂ to SiCl₄=2:1, yielding trichlorosilane.

### Comparative Example 1

Trichlorosilane was prepared in the same manner as in Example 1, with the exception that hydrochlorination was directly carried out without incorporating MG-Si in a Cu solution.

### Comparative Example 2

In a fixed bed reactor, 170 g of MG-Si was mixed with as a solid Cu catalyst CuCl₂ in an amount of 0.23 wt % relative to MG-Si based on the weight of Cu in CuCl₂, after which hydrochlorination was carried out for 2 to 10 hr under conditions of a temperature of 525° C., a pressure of 20 barG, and a molar ratio of H₂ to SiCl₄=2:1, yielding trichlorosilane.

### Experimental Example

### Analysis of X-Ray Diffraction Pattern of MG-Si

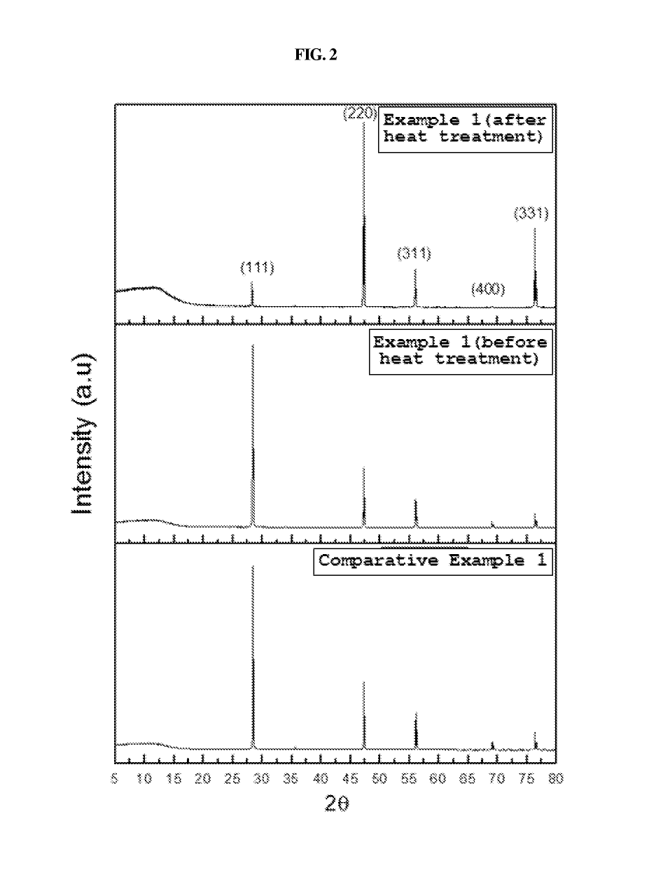

To analyze whether Cu-silicide was formed on the surface of MG-Si, the results of observing the MG-Si of Example 1 and the MG-Si having no Cu compound of Comparative Example 1 by XRD are illustrated in FIG. 2.

As illustrated in FIG. 2, based on the results of analysis of the structure of Si coated with the Cu compound by a solution process before and after heat treatment, as Cu-silicide was formed through heat treatment, changes in the structure of MG-Si were observed.

Observation of Surface of MG-Si

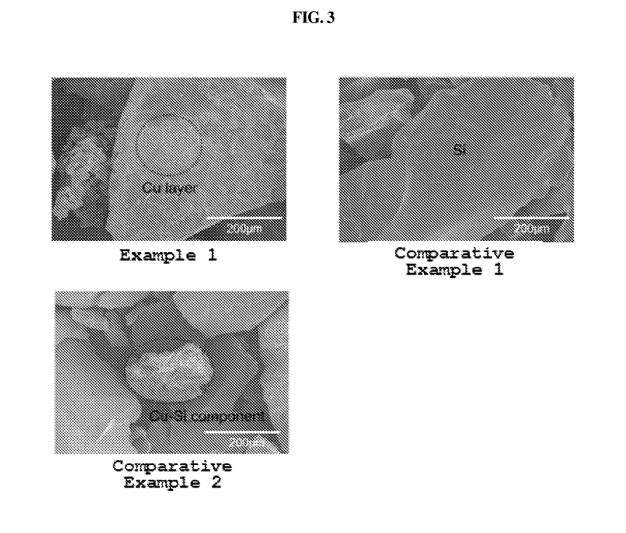

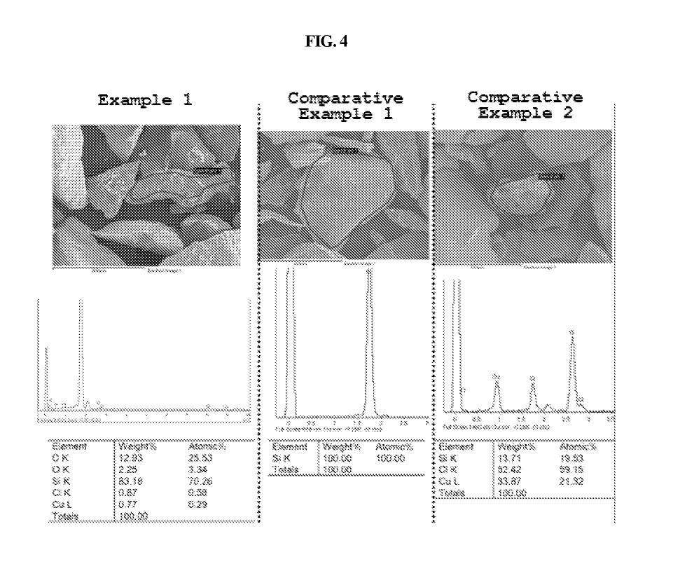

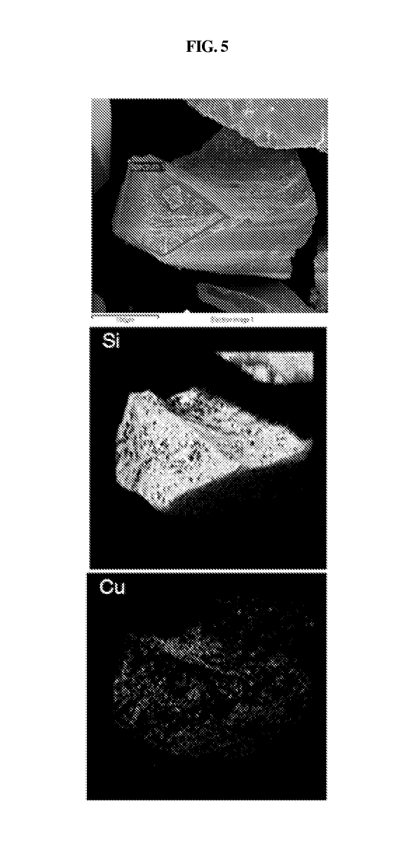

The results of observing the surface of MG-Si before heat treatment in Example 1 and Comparative Examples 1 and 2 using SEM with 200× magnification are illustrated in FIG. 3. Also, the results of observing the heat treated surface of Example 1 using SEM and SEM-EDX are illustrated in FIG. 5. The results of measuring Example 1 and Comparative Examples 1 and 2 using SEM-EDX to analyze the components of Cu-silicide are illustrated in FIG. 4.

As illustrated in FIG. 3, the Cu compound was formed on the surface of Si in Example 1 before heat treatment. As illustrated in FIG. 5, MG-Si was incorporated in the Cu solution, the solvent was removed, and then heat treatment was performed, so that Cu atoms were uniformly formed on the surface of MG-Si.

As illustrated in FIGS. 3, 4 and 5, by heat treatment after removal of the solvent from MG-Si, Cu-silicide was uniformly formed on the surface of MG-Si, and the Cu layers having a thickness of ones of μm were formed on the surface of Si. The reaction area of MG-Si by such Cu layers may be remarkably increased, and metal impurities in MG-Si are exposed to the outside and may thus act as a catalyst.

Measurement of Yield of Trichlorosilane

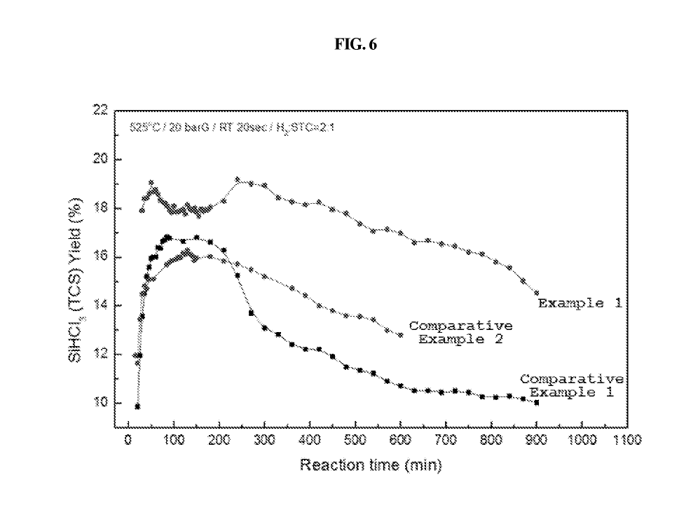

The yield of trichlorosilane (SiHCl₃) depending on the reaction time was measured in Example 1 and Comparative Examples 1 and 2. The results are illustrated in FIG. 6.

As illustrated in FIG. 6, in Example 1 where hydrochlorination was carried out using MG-Si having Cu-silicide uniformly formed thereon according the present invention, the yield was increased by approximately 33% compared to in Comparative Example 1 where hydrochlorination was carried out only with MG-Si (Example 1: yield 18.2%, Comparative Example 1: 13.7%). Also, the yield in Example 1 was increased by about 21% compared to in Comparative Example where hydrochlorination was carried out using the Cu catalyst at the same concentration (Example 1: yield 18.2%, Comparative Example 2: 14.9%).

1. A method of preparing trichlorosilane, comprising:
forming a copper (Cu) compound coating layer on silicon (Si);
heat treating the silicon having the copper compound coating layer formed thereon to a temperature equal to or higher than a melting temperature of the copper compound, thus forming copper silicide (Cu-silicide) on the silicon; and
supplying silicon tetrachloride and hydrogen to the silicon having copper silicide formed thereon, so that hydrochlorination is carried out.

2. The method of claim 1, wherein forming the copper compound coating layer is performed by incorporating the silicon in a solution containing the copper compound.

3. The method of claim 2, wherein the solution includes one or more solvents selected from the group consisting of methanol, ethanol, isopropanol, and butanol.

4. The method of claim 1, wherein forming the copper silicide is performed in a mixed gas atmosphere containing hydrogen.

5. The method of claim 4, wherein the mixed gas includes 10 wt % or less of hydrogen and a remainder of inert gas.

6. The method of claim 1, wherein the hydrochlorination is carried out without addition of a catalyst.

7. The method of claim 1, wherein the copper silicide is formed on a surface of the silicon.

8. The method of claim 1, wherein the copper compound includes CuCl, CuCl₂, Cu₂O, CuO, Cu, or mixtures thereof.

9. The method of claim 1, wherein the silicon is metallurgical silicon (MG-Si) having an average particle size of 10 to 500 μm.

10. The method of claim 1, wherein heat treating is performed at a temperature of 300 to 800° C. and a pressure of 1 to 20 bar.

11. The method of claim 1, wherein the hydrochlorination is carried out at a temperature of 300 to 800° C. and a pressure of 1 to 50 bar.
